(19) United States
(12) Patent Application Publication
(10) Pub. No.: US 2016/0369077 A1
(43) Pub. Date: Dec. 22, 2016

(54) RIGID POLYURETHANE FOAM AND MANUFACTURING METHOD AND APPLICATIONS THEREOF

(71) Applicant: HISENSE RONSHEN (GUANGDONG) REFRIGERATOR CO., LTD., Guangdong (CN)

(72) Inventors: Feng HU, Guangdong (CN); Lijun CAO, Guangdong (CN); Zhe HU, Guangdong (CN); Li LIU, Guangdong (CN)

(21) Appl. No.: 15/253,100

(22) Filed: Aug. 31, 2016

Related U.S. Application Data
(63) Continuation of application No. PCT/CN2014/072883, filed on Mar. 5, 2014.

(51) Int. Cl. C08J 9/14; F25D 23/06; C08J 9/00; C08G 18/40; C08G 18/76

(52) U.S. Cl. CPC C08J 9/149; C08J 9/144; C08J 9/141; C08G 18/4018; C08G 18/7671; C08J 9/0042; F25D 23/066; C08J 2203/162; C08J 2205/10; C08J 2375/08; C08J 2203/14; C08J 2203/182; C08G 2101/0025

(57) ABSTRACT

The embodiments of the present invention provide a rigid polyurethane foam, being prepared at least from the following raw materials in parts by weight through mixing and reaction: 135-165 parts of polyisocyanate, 100 parts of polyol composition, 10-16 parts of C-pentane, 1.8-2.3 parts of catalyst, 1.8-2.5 parts of silicone oil, 1.6-2.4 parts of water, and 1-chloro-3,3,3-trifluoropropene accounting for 1%-3% of the total weight of the raw materials. The embodiments of the present invention also provide a preparation method of the rigid polyurethane foam and applications of the rigid polyurethane foam in the industries of refrigerators and freezers.

### FIELD OF TECHNOLOGY

The present application relates to the technical field of rigid polyurethane foams, and particularly to a rigid polyurethane foam and a manufacturing method and applications thereof.

### BACKGROUND

C-pentane, as the present most consumable and most popular rigid polyurethane foam foaming agent in the industries of refrigerators and freezers both in China and abroad, has the advantages of good environmental friendliness and simple operation. Furthermore, C-pentane as a petrochemical product has mature refining process, easily available and low price, and thus has been widely used in refrigerating appliances as a preferred foaming agent in replace of CFC-11 (trichlorofluoromethane) and HCFC-141b (dichlorofluoroethane). C-pentane dominates the field of polyurethane foaming agents.

In Version 1 of Handbook of Plastic Industry by L I, Junxian in 1999, relevant theoretical research stated that the thermal conductivity of the foam is composed of several factors:

λ_{F}=λ_{G}+λ_{S}+λ_{R}+λ_{C},

where: λ_{F}: thermal conductivity of the rigid foam;

λ_{G}: thermal conductivity of gas inside cells;

λ_{S}: thermal conductivity of solids;

λ_{R}: radiation conductivity; and

λ_{C}: convective thermal conductivity.

In this formula, the thermal conductivity of solids is relatively constant, and the convective thermal conductivity may be ignored when the size of rigid foam cells is less than 2 mm. In the case where the main gas components inside the cells are known, radiation conductivity is the main factor which influences the thermal conductivity of the rigid foam. The most effective approach to reduce the radiation conductivity is to reduce the size of cells.

### SUMMARY OF THE DISCLOSURE

The embodiments of the present application provide a rigid polyurethane foam with low thermal conductivity. The appropriate adjustment of the formulation can cause the thermal conductivity of the prepared rigid polyurethane foam to be greatly reduced (which can be as low as 0.01800 W/m·K or below).

Another aspect of the embodiments is to provide a method for preparing the rigid polyurethane foam.

Yet another aspect of the embodiments is to provide application of the rigid polyurethane foam in manufacturing refrigerators and freezers.

Specifically, the embodiments provide the following technical solutions.

A rigid polyurethane foam is provided, and the rigid polyurethane foam is prepared at least from the following raw materials in parts by weight through mixing and reaction:

135-165 parts of polyisocyanate;

100 parts of polyol composition;

10-16 parts of C-pentane;

1.8-2.3 parts of catalyst;

1.8-2.5 parts of silicone oil;

1.6-2.4 parts of water;

and 1-chloro-3,3,3-trifluoropropene accounting for 1%-3% of the total weight of the raw materials.

A method for preparing the rigid polyurethane foam is provided, comprising the following steps:

S1: evenly mixing polyol composition, C-pentane, 1-chloro-3,3,3-trifluoropropene, catalyst, silicone oil and water in proportion; and

S2: evenly mixing the mixture obtained in step S1 with polyisocyanate in proportion, and then foaming at a pressure from 110 bar to 160 bar.

A method for manufacturing refrigerators or freezers is provided, comprising: making thermal insulating material by the rigid polyurethane foam in any one of the embodiments.

### BRIEF DESCRIPTION OF THE DRAWINGS

FIG. 1 is an electron micrograph of the rigid polyurethane foam prepared in embodiments and comparison examples, wherein the left picture is the foam prepared from a single component (C-pentane only) system in Comparison Example 3, the middle picture is the foam prepared from a C-pentane+HFO-1233zd system without aromatic polyester in Comparison Example 4, and the right picture is the foam prepared in Embodiment 3.

### DETAILED DESCRIPTION OF THE EMBODIMENTS

The embodiments of the present application will be further described below by the following specific embodiments. Those embodiments are merely typical illustrations of the present application, and the present application is not limited thereto.

A rigid polyurethane foam is provided in one embodiment, and the rigid polyurethane foam is prepared at least from the following raw materials in parts by weight through mixing and reaction:

135-165 parts of polyisocyanate;

100 parts of polyol composition;

10-16 parts of C-pentane;

1.8-2.3 parts of catalyst;

1.8-2.5 parts of silicone oil;

1.6-2.4 parts of water;

and 1-chloro-3,3,3-trifluoropropene accounting for 1%-3% of the total weight of the raw materials.

Wherein, the polyisocyanate comprises polyaryl polymethyne isocyanate.

Wherein, the polyol composition comprises polyether polyols and aromatic polyester polyols.

Wherein, the polyether polyols may be prepared by the addition polymerization reaction of one or more of sucrose, glycerine, toluenediamine, sorbitol, ethylenediamine, diol or ethanolamine, as initiators, and oxyalkylene. The oxyalkylene may comprise propylene oxide, ethylene oxide or the like.

Wherein, the aromatic polyester polyols may be prepared by the synthesis of at least one of phthalic acid, isophthalic acid, terephthalic acid, halogen substituted benzenedicarboxylate and anhydrides thereof and at least one of ethylene glycol, propylene glycol, diethylene glycol, neopentyl glycol and bisphenol A with an aromatic ring.

C-pentane has the advantages of good environmental friendliness and simple operation. However, C-pentane also has the following defects: C-pentane is flammable, and it is thus required to construct ventilation facilities during the production and application; the resulting foam cannot satisfy the increasing standards of energy efficiency of household appliances due to its low thermal insulating property and high overall energy consumption; and high boiling point and low vapor pressure result in low strength and high filling intensity of the foam and more foaming raw materials are thus consumed.

The disadvantages of high energy consumption and high resource consumption of C-pentane have always been problems to be overcome in the PU field, but it is difficult to achieve a breakthrough effectively. The root cause is that it is difficult to find an approach that can meet the requirements of environmental regulations and make up inherent defects of C-pentane. This situation does not change until the inventors found that HFO-1233zd (1-chloro-3,3,3-trifluoropropene) can be mixed with C-pentane so as to make up the defects of the C-pentane.

The physical and chemical properties of C-pentane and HFO-1233zd are shown in Table 1.

TABLE 1
Physical and chemical properties of C-pentane and HFO-1233zd

| | | ODP | GWP | | Saturated | Thermal | |
|---|---|---|---|---|---|---|---|
| | | (Ozone | (Global | | vapor | conductivity | |
| Foaming | Molecular | Depleting | Warming | Boiling | pressure | (20° C., | Explosion |
| agent | structure | Potential) | Potential) | point (° C.) | KPa (20° C.) | mW/m.K) | limit (%) |
| C-pentane | 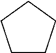 | 0 | 11 | 49 | 45 | 12 | 1.4-8.1 |
| HFO-1233 zd | 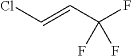 | ≈0* | 7 | 19 | 108 | 9 | / |

*Verified by the National Institute of Standards and Technology (NIST)

From this table, it can be known that the ozone depleting potential (ODP) of both C-pentane and HFO-1233zd is 0; the global warming potential (GWP) of both C-pentane and HFO-1233zd is less than 15; HFO-1233zd also has characteristics of low boiling point, low thermal conductivity and high vapor pressure and its molecules have a structure with multiple fluorine atoms, so it is expected to be used as a nucleating additive to make up the inherent defects of C-pentane.

Mixing a certain amount of HFO-1233zd with C-pentane can effectively make up the weaknesses of C-pentane (foaming agent) such as high thermal conductivity and low foam strength and improve the performance of the foam. In addition, it was unexpectedly found by the inventors that the HFO-1233zd may also be used as a nucleating agent since its molecules have a structure with multiple fluorine atoms, and the application of the HFO-1233zd in manufacturing rigid polyurethane foam plastics can result in smaller, finer and more uniform cells, thereby facilitating reducing the thermal conductivity of the foam and improving the structure and strength of cells. Furthermore, the HFO-1233zd is not flammable, so the safety of the C-pentane foaming production can be improved.

Meanwhile, aromatic polyether polyols and aromatic polyester polyols are introduced into the polyol composition in the raw materials, and therefore, the application of the polyol composition in manufacturing rigid polyurethane foam plastics can result in smaller, finer and more uniform cells, so that the thermal conductivity of the foam is further reduced and a rigid polyurethane foam with low thermal conductivity is manufactured.

Wherein, the aromatic polyether polyols obtained by the addition polymerization reaction of toluenediamine as an initiator and oxyalkylene may account for 15-40 parts in weight in the polyol composition. This range includes any specific numerical values, for example, but not limited to, 15 parts, 20 parts, 25 parts, 30 parts, 35 parts or 40 parts.

Wherein, the aromatic polyether polyols obtained by the addition polymerization reaction of toluenediamine as an initiator and oxyalkylene may account for 20-25 parts in weight in the polyol composition.

Wherein, the aromatic polyester polyols may account for 8-15 parts in weight in the polyol composition. This range includes any specific numerical values, for example, but not limited to, 8 parts, 9 parts, 10 parts, 11 parts, 12 parts, 13 parts, 14 parts or 15 parts.

Wherein, the aromatic polyester polyols may account for 12-15 parts in weight in the polyol composition.

In the rigid polyurethane foam, 1-chloro-3,3,3-trifluoropropene may account for 1%-3% of the total weight of the raw materials. This range includes any specific numerical values, for example, but not limited to, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9% or 3.0%.

In the rigid polyurethane foam, 1-chloro-3,3,3-trifluoropropene may account for 2%-3% of the total weight of the raw materials.

In the rigid polyurethane foam, 1-chloro-3,3,3-trifluoropropene may account for 2.5%-3% of the total weight of the raw materials.

As an another embodiment, the rigid polyurethane foam is prepared at least from the following raw materials in parts by weight:

140-160 parts of polyisocyanate;

100 parts of polyol composition;

11-14 parts of C-pentane;

1.8-2.1 parts of catalyst;

1.9-2.4 parts of silicone oil;

1.9-2.2 parts of water; and

1-chloro-3,3,3-trifluoropropene accounting for 2.0%-3.0% of the total weight of the raw materials.

As a further embodiment, the rigid polyurethane foam is prepared at least from the following raw materials in parts by weight:

145-155 parts of polyisocyanate;

100 parts of polyol composition;

11.0-12.5 parts of C-pentane;

1.8-2.0 parts of catalyst;

2.0-2.3 parts of silicone oil;

1.9-2.1 parts of water; and

1-chloro-3,3,3-trifluoropropene accounting for 2.5%-3.0% of the total weight of the raw materials.

In another aspect, a method for preparing the above rigid polyurethane foam is provided, comprising the following steps:

S1: evenly mixing polyol composition, C-pentane, 1-chloro-3,3,3-trifluoropropene, catalyst, silicone oil and water in proportion; and

S2: evenly mixing the mixture obtained in step S1 with polyisocyanate in proportion, and then foaming at a pressure from 110 bar to 160 bar.

As an another embodiment, the 1-chloro-3,3,3-trifluoropropene in step S1 is cooled to 10° C. to 19° C. and then evenly mixed with C-pentane and polyol composition, and this range includes any specific numerical values, for example, but not limited to, 10° C., 11° C., 12° C., 13° C., 14° C., 15° C., 16° C., 17° C., 18° C. or 19° C.; wherein the temperature of the C-pentane is from 10° C. to 30° C., and this range includes any specific numerical values, for example, but not limited to, 10° C., 12° C., 14° C., 16° C., 18° C., 20° C., 22° C., 24° C., 26° C., 28° C. or 30° C.; the temperature of the mixture after the mixing in step S1 is from 18° C. to 25° C., and this range includes any specific numerical values, for example, but not limited to, 18° C., 19° C., 20° C., 21° C., 22° C., 23° C., 24° C. or 25° C.

In a further aspect, a method for manufacturing refrigerators or freezers is provided, comprising: making thermal insulating material by the above rigid polyurethane foam. That is to say, the above rigid polyurethane foam is applied in manufacturing refrigerators or freezers as the thermal insulating material.

Compared with the prior art, the embodiments of the present application mainly have the following beneficial effects.

(1) In the embodiments of the present application, C-pentane is used as the main component foaming agent, and a certain amount of HFO-1233zd is added. In this way, the advantages of low cost and mature technology of C-pentane are fully utilized, and the HFO-1233zd also has characteristics of low boiling point, low thermal conductivity and high vapor pressure. The coordinated use of C-pentane and HFO-1233zd reduces the thermal conductivity of the foam and increases the strength of the foam.

(2) The component HFO-1233zd in the embodiments of the present application contains a structure with multiple fluorine atoms, and thus can be used as a nucleating agent. This can result in smaller, finer and more uniform cells, and the structure and strength of cells are further improved, thereby facilitating reducing the thermal conductivity, improving the performance of the foam, and being more energy-saving.

(3) The component HFO-1233zd in the embodiments of the present application is not flammable and contains no volatile organics (VOC), the ozone depleting potential (ODP) thereof is 0, and the global warming potential (GWP) is less than 10. The HFO-1233zd itself has the function of a foaming agent. The HFO-1233zd is environmentally friendly.

(4) Since the HFO-1233zd has a low boiling point so that the foam may have excellent fluidity, and also has a high vapor pressure. Manufacturing the rigid polyurethane foam by the method of the embodiments can increase the strength of the foam, reduce the consumption of foaming raw materials, and save resources.

(5) In the embodiments of the present application, the premixed polyether polyol formulation is optimized: preferred aromatic polyether monomers and aromatic polyester monomers are used so that the cells are smaller and finer and the thermal conductivity is reduced; with the addition of the HFO-1233zd, the polyurethane foam with low thermal conductivity can be prepared.

The cells of the rigid polyurethane foam plastics prepared from the composition of the embodiments are finer and more uniform, so that the thermal conductivity (which can be as low as 0.01800 W/m·K or below) is greatly reduced and the strength of the foam is increased; the thermal insulating effect of the thermal insulating layer is improved, and the energy consumption is reduced; it is good in environmental friendliness (ODP=0, GWP<15), and it is safer than foaming by a single component (C-pentane only). The rigid polyurethane foam according to the embodiments of the present application has a positive role in promoting upgrading and updating of the existing C-pentane foaming technologies for refrigerators.

The embodiments will be described in details in blow.

The following raw materials are used in the embodiments of the present application:

polyether A: obtained by polymerization with oxyalkylene by using sucrose as an initiator; functionality: 8; and hydroxyl value: 370-415 mg/KOH/g;

polyether B: obtained by polymerization with oxyalkylene by using sucrose and glycerine as initiators; functionality: 5-6; and hydroxyl value: 360-390 mg/KOH/g;

polyether C: obtained by polymerization with oxyalkylene by using sorbitol as an initiator; functionality: 6: and hydroxyl value: 480-500 mg/KOH/g;

polyether D: obtained by polymerization with oxyalkylene by using toluenediamine as an initiator; functionality: 4; and hydroxyl value: 400-420 mg/KOH/g;

polyether E: obtained by polymerization with oxyalkylene by using ethylenediamine as an initiator; functionality: 4; and hydroxyl value: 630-700 mg/KOH/g;

polyester F: obtained by condensation of aromatic carboxylic acids or anhydrides and alcohols; functionality: 2-3; and hydroxyl value: 300-330 mg/KOH/g; PS3152, produced by Nanjing Stepan Jinling Chemical Co., Ltd.;

C-pentane: produced by Shunde Meilong Cyclopentane Chemical Co., Ltd.;

HFO-1233zd foaming agent: produced by Honeywell, Inc.;

catalyst: TMR-2, PC-5, PC-8, produced by Air Products and Chemicals, Inc.;

silicone oil: a surfactant, produced by Evonik Degussa;

polyisocyanate: PM2010, produced by Yantai Wanhua Chemical Group Co., Ltd.; and

production equipment: high-pressure foaming machines produced by Hennecke GmbH.

Other raw materials in the embodiments of the present application may be purchased from the market.

Embodiments 1-2 are rigid polyurethane foams prepared according to common methods of the embodiments, and Embodiments 3-4 are rigid polyurethane foams prepared according to preferred methods of the embodiments. The preparation methods of Embodiments 1-4 are described on above, and will not be repeated here.

The raw materials used in Embodiments 1-4 and Comparison examples 1-3 and the properties of the prepared rigid polyurethane foams thereof are listed on table 2.

TABLE 2

| | | | | | Comparison | Comparison | Comparison |
|---|---|---|---|---|---|---|---|
| | Embodiment 1 | Embodiment 2 | Embodiment 3 | Embodiment 4 | example 1 | example 2 | example 3 |
| Polyether A | 35 | / | 25 | / | 25 | 25 | 35 |
| Polyether B | / | 40 | 10 | 30 | 10 | 10 | / |
| Polyether C | 20 | 23 | 20 | 25 | 20 | 20 | 25 |
| Polyether D | 20 | 25 | 20 | 20 | 20 | 20 | 25 |
| Polyether E | 10 | / | 10 | 13 | 10 | 10 | 15 |
| Polyester F | 15 | 12 | 15 | 12 | 15 | 15 | / |
| Catalyst | 2.0 | 2.0 | 2.0 | 2.0 | 2.0 | 2.0 | 2.1 |
| Silicone oil | 2.3 | 2.3 | 2.3 | 2.3 | 2.3 | 2.3 | 2.3 |
| Water | 1.95 | 2.05 | 2.0 | 2.1 | 2.0 | 2.0 | 2.0 |
| PM2010 | 141 | 148 | 150 | 160 | 144 | 155 | 150 |
| (polyisocyanate) | | | | | | | |
| C-pentane | 12.5 | 12.0 | 11.5 | 11.0 | 11.0 | / | 13.0 |
| HFO-1233zd/total | 1.50 | 2.05 | 2.50 | 2.95 | 3.65 | 10.00 | / |
| weight of the raw | | | | | | | |
| materials (%) | | | | | | | |
| Free rise foam | 24.20 | 23.75 | 23.60 | 23.50 | 23.68 | 24.00 | 25.44 |
| density (kg/m³) | | | | | | | |
| Density of molded | 32.30 | 32.06 | 31.56 | 31.78 | 31.54 | 31.47 | 35.51 |
| foam core (kg/m³) | | | | | | | |
| Thermal conductivity | 0.01910 | 0.01856 | 0.01788 | 0.01757 | 0.01748 | 0.01728 | 0.02034 |
| (W/m · K) | | | | | | | |
| Compressive strength | 0.130 | 0.133 | 0.138 | 0.139 | 0.140 | 0.142 | 0.141 |
| (vertical) Mpa | | | | | | | |
| Size stability % | −0.41 | −0.30 | −0.22 | −0.26 | −0.22 | −0.27 | −0.19 |
| (−30° C., 24 h) | | | | | | | |

It can be known from Embodiments 1-4 that, in the rigid polyurethane foam plastics prepared from a foaming system which is formed by adding a proper amount of HFO-1233zd (an additive) that may be used as a nucleating agent into the C-pentane system and then optimizing the premixed polyether polyol formulation and adding a certain amount of preferred aromatic polyethers and aromatic polyesters or other components in the premixed polyether polyols, the thermal conductivity of the foam is significantly reduced, and the thermal insulating effect is improved and is significantly better than the single-component (C-pentane only) foaming system in Comparison Example 3.

It can be known from Embodiments 1-4 and Comparison Example 3 that the compressive strengths are close to each other although there is a difference of about 3 kg/m³ in density. It is indicated that the addition of HFO-1233zd, aromatic polyether polyols and aromatic polyester polyols may also increase the strength of the foam.

It can be known from Embodiments 1-4 and Comparison Examples 1-2 that the thermal conductivity of the foam is minimized (which can be as low as 0.01800 mW/m·K or below) when HFO-1233zd accounts for about 2.5% or more of the total weight of the foaming raw materials. At this moment, if the amount of HFO-1233zd is continuously increased, within a certain range, the improvement and reduction of the thermal conductivity are not obvious, because the main components of the foaming agent inside the cells are still C-pentane and a proper amount of HFO-1233zd that may be used as the nucleating agent. In this case, it is not obvious to continuously add a certain amount of HFO-1233zd to facilitate nucleation. The effect of the HFO-1233zd in improving the thermal conductivity as the foaming agent is also not obvious because its content in percentage is too small. When analyzed in consideration of cost and foam performance, it is regarded to be the most cost-effective when HFO-1233zd accounts for 2.5%-3.0% of the total weight of the foaming raw materials.

The raw materials used in Embodiment 3 and Comparison examples 4-5 and the properties of the prepared rigid polyurethane foams thereof are listed on table 3.

TABLE 3

| | | Comparison | Comparison |
|---|---|---|---|
| | Embodiment 3 | Example 4 | Example 5 |
| Polyether A | 25 | 35 | 25 |
| Polyether B | 10 | 10 | 10 |
| Polyether C | 20 | 25 | 20 |
| Polyether D | 20 | 20 | / |
| Polyether E | 10 | 10 | 15 |
| Polyester F | 15 | / | / |
| Catalyst | 2.0 | 2.0 | 2.0 |
| Silicone oil | 2.3 | 2.3 | 2.3 |
| Water | 2.0 | 2.0 | 2.0 |
| PM2010 (polyisocyanate) | 150 | 150 | 150 |
| C-pentane | 11.5 | 11.5 | 11.5 |
| HFO-1233zd/total | 2.50 | 2.50 | 2.50 |
| weight of the raw | | | |
| materials (%) | | | |
| Free rise foam density | 23.60 | 23.70 | 23.84 |
| (kg/m³) | | | |
| Density of molded | 31.56 | 31.97 | 31.92 |
| foam core (kg/m³) | | | |
| Thermal conductivity | 0.01788 | 0.01811 | 0.01823 |
| (W/m · K) | | | |
| Compressive strength | 0.138 | 0.135 | 0.134 |
| (vertical) Mpa | | | |
| Size stability % | −0.22 | −0.25 | −0.24 |
| (−30° C., 24 h) | | | |

It can be known from Embodiment 3 and Comparison Examples 4-5 that the thermal conductivity of the foam can be most effectively improved by adding a proper amount of HFO-1233zd in the C-pentane system and by using aromatic polyether polyols and aromatic polyester polyols in the premixed polyether polyol formulation.

The densities of the thermal insulating materials, which are made of the rigid polyurethane foams prepared in Embodiment 3 and Comparison Example 3 respectively, in the refrigerator or the freezer are listed in table 4.

TABLE 4

| | Thermal insulating | Thermal insulating |
|---|---|---|
| | materials manufactured | materials manufactured |
| | by the rigid polyurethane | by the rigid polyurethane |
| | foams prepared in | foams prepared in |
| | Embodiment 3 | Comparison Example 3 |
| Refrigerant | 7450 | 8200 |
| charge (g) | | |
| 1 (kg/m³) | 31.17 | 36.54 |
| 2 (kg/m³) | 31.75 | 35.44 |
| 3 (kg/m³) | 31.97 | 34.92 |
| 4 (kg/m³) | 31.52 | 35.66 |
| 5 (kg/m³) | 31.65 | 34.64 |
| Average | 31.66 | 35.51 |
| density (kg/m³) | | |
| Range of | 0.8 | 1.9 |
| density (Max-min) | | |

Note:
Those embodiments and comparison examples are all foamed by high-pressure foaming machines in two-door refrigerator molds having a volume of 300 L produced by Hisense Ronshen Refrigerator Co., LTD.

It can be known from Table 4 that the range of density (max-min) of the refrigerator foam manufactured in Embodiment 3 is 0.8, while the range of density (max-min) of the refrigerator foam manufactured in Comparison Example 3 is 1.9. It is indicated that the addition of HFO-1233zd causes the foam to have more excellent fluidity.

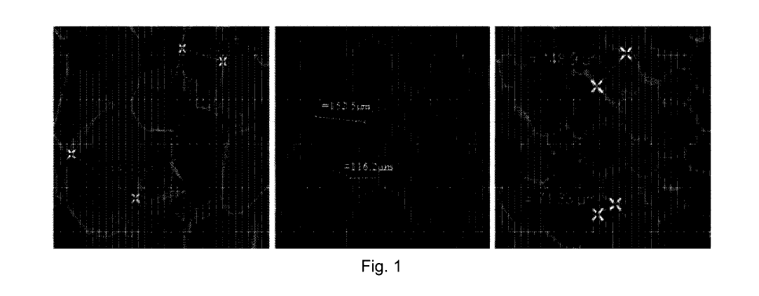

In FIG. 1, the left picture is the foam prepared from a single component (C-pentane only) system in Comparison Example 3, the middle picture is the foam prepared from a C-pentane+HFO-1233zd system without aromatic polyester in Comparison Example 4, and the right picture is the foam prepared in Embodiment 3. It can be seen from the electron micrograph of FIG. 1 that the size of cells gradually decreases from left picture to right picture. It is indicated that the addition of HFO-1233zd and aromatic polyester polyols causes cells of the rigid polyurethane foam more uniform and finer.

The application of HFO-1233zd (an additive) in the C-pentane foaming system as a nucleating agent and the improvement of the formulation by using aromatic polyethers and aromatic polyesters can effectively overcome the defect of high thermal conductivity which occurs when the C-pentane-only system is used. Meanwhile, the safety of foaming by C-pentane can be improved since HFO-1233zd is not flammable. Furthermore, due to VOC=0, ODP=0 and GWP<10, by the method for preparing the rigid polyurethane foam from the composition of the embodiments of the present application, the energy-saving effect, economic benefits, safety and environmental friendliness of refrigerator products can be better realized.

The foregoing descriptions are merely preferred embodiments of the present application and not intended to limit the present application. Any modifications, equivalent replacements, improvements or the like made without departing from the spirit and principle of the embodiments of the present application shall be regarded as falling into the protection scope of the present application.

What is claimed is:

1. A rigid polyurethane foam, being prepared at least from the following raw materials in parts by weight through mixing and reaction:
135-165 parts of polyisocyanate;
100 parts of polyol composition;
10-16 parts of C-pentane;
1.8-2.3 parts of catalyst;
1.8-2.5 parts of silicone oil;
1.6-2.4 parts of water; and
1-chloro-3,3,3-trifluoropropene accounting for 1%-3% of the total weight of the raw materials;
Wherein, the polyol composition comprises polyether polyols and aromatic polyester polyols, and the aromatic polyester polyols account for 8-15 parts in weight in the polyol composition.

2. The rigid polyurethane foam according to claim 1, wherein the rigid polyurethane foam is prepared at least from the following raw materials in parts by weight through mixing and reaction:
140-160 parts of polyisocyanate;
100 parts of polyol composition;
11-14 parts of C-pentane;
1.8-2.1 parts of catalyst;
1.9-2.4 parts of silicone oil;
1.9-2.2 parts of water, and
1-chloro-3,3,3-trifluoropropene accounting for 2.0%-3.0% of the total weight of the raw materials.

3. The rigid polyurethane foam according to claim 1, wherein the rigid polyurethane foam is prepared at least from the following raw materials in parts by weight through mixing and reaction:
145-155 parts of polyisocyanate;
100 parts of polyol composition;
11.5-12.5 parts of C-pentane;
1.8-2.0 parts of catalyst;
2.0-2.3 parts of silicone oil;
1.9-2.1 parts of water; and
1-chloro-3,3,3-trifluoropropene accounting for 2.5%-3.0% of the total weight of the raw materials.

4. The rigid polyurethane foam according to claim 1, wherein the polyisocyanate comprises polyaryl polymethyne isocyanate.

5. The rigid polyurethane foam according to claim 1, characterized in that the polyether polyols are prepared by the addition polymerization reaction of one or more of sucrose, glycerine, toluenediamine, sorbitol, ethylenediamine, diol or ethanolamine, as initiators, and oxyalkylene.

6. The rigid polyurethane foam according to claim 5, wherein the aromatic polyether polyols obtained by the addition polymerization reaction of toluenediamine as an initiator and oxyalkylene account for 15-40 parts in weight in the polyol composition.

7. The rigid polyurethane foam according to claim 6, wherein the aromatic polyether polyols obtained by the addition polymerization reaction of toluenediamine as an initiator and oxyalkylene account for 20-25 parts in weight in the polyol composition.

8. The rigid polyurethane foam according to claim 1, wherein the aromatic polyester polyols are prepared by the synthesis of at least one of phthalic acid, isophthalic acid, terephthalic acid, halogen substituted benzenedicarboxylate and anhydrides thereof and at least one of ethylene glycol, propylene glycol, diethylene glycol, neopentyl glycol and bisphenol A with an aromatic ring.

9. The rigid polyurethane foam according to claim 1, wherein the aromatic polyester polyols account for 12-15 parts in weight in the polyol composition.

10. The rigid polyurethane foam according to claim 1, wherein in the rigid polyurethane foam, 1-chloro-3,3,3-trifluoropropene accounts for 2%-3% of the total weight of the raw materials.

11. The rigid polyurethane foam according to claim 1, wherein in the rigid polyurethane foam, 1-chloro-3,3,3-trifluoropropene accounts for 2.5%-3% of the total weight of the raw materials.

12. A method for preparing rigid polyurethane foam, comprising the following steps:
S1: evenly mixing 100 parts of polyol composition, 10-16 parts of C-pentane, 1-chloro-3,3,3-trifluoropropene accounting for 1%-3% of the total weight of the raw materials, 1.8-2.3 parts of catalyst, 1.8-2.5 parts of silicone oil and 1.6-2.4 parts of water, Wherein, the polyol composition comprises polyether polyols and aromatic polyester polyols, and the aromatic polyester polyols account for 8-15 parts in weight in the polyol composition; and
S2: evenly mixing the mixture obtained in step S1 with 135-165 parts of polyisocyanate, and then foaming at a pressure from 110 bar to 160 bar.

13. The method for preparing rigid polyurethane foam according to claim 12, wherein the 1-chloro-3,3,3-trifluoropropene in step S1 is cooled to 10° C. to 19° C. and then evenly mixed with C-pentane and polyol composition, wherein the temperature of the C-pentane is from 10° C. to 30° C., and the temperature of the mixture after the mixing in step S1 is from 18° C. to 25° C.

14. The method for preparing rigid polyurethane foam according to claim 12, wherein in step S1, the polyol composition is 100 parts, the C-pentane is 11-14 parts, the catalyst is 1.8-2.1 parts, the silicone oil is 1.9-2.4 parts, the water is 1.9-2.2 parts and 1-chloro-3,3,3-trifluoropropene accounts for 2.0%-3.0% of the total weight of the raw materials, and in step S2, the polyisocyanate is 140-160 parts.

15. The method for preparing rigid polyurethane foam according to claim 12, wherein in step S1, the polyol composition is 100 parts, the C-pentane is 11.5-12.5 parts, the catalyst is 1.8-2.0 parts, the silicone oil is 2.0-2.3 parts, the water is 1.9-2.1 parts and 1-chloro-3,3,3-trifluoropropene accounts for 2.5%-3.0% of the total weight of the raw materials, and in step S2, the polyisocyanate is 145-155 parts.

16. The method for preparing rigid polyurethane foam according to claim 12, wherein in step S1, the aromatic polyether polyols obtained by the addition polymerization reaction of toluenediamine as an initiator and oxyalkylene account for 15-40 parts in weight in the polyol composition.

17. A method for manufacturing refrigerators or freezers, comprising: making thermal insulating material by the rigid polyurethane foam, wherein the rigid polyurethane foam is prepared at least from the following raw materials in parts by weight through mixing and reaction:
135-165 parts of polyisocyanate;
100 parts of polyol composition;
10-16 parts of C-pentane;
1.8-2.3 parts of catalyst;
1.8-2.5 parts of silicone oil;
1.6-2.4 parts of water; and
1-chloro-3,3,3-trifluoropropene accounting for 1%-3% of the total weight of the raw materials;
Wherein, the polyol composition consists of polyether polyols and aromatic polyester polyols, and the aromatic polyester polyols account for 8-15 parts in weight in the polyol composition.

18. The method for manufacturing refrigerators or freezers according to claim 17, wherein the rigid polyurethane foam is prepared at least from the following raw materials in parts by weight through mixing and reaction:
140-160 parts of polyisocyanate;
100 parts of polyol composition;
11-14 parts of C-pentane;
1.8-2.1 parts of catalyst;
1.9-2.4 parts of silicone oil;
1.9-2.2 parts of water, and
1-chloro-3,3,3-trifluoropropene accounting for 2.0%-3.0% of the total weight of the raw materials.

19. The method for manufacturing refrigerators or freezers according to claim 17, wherein the rigid polyurethane foam is prepared at least from the following raw materials in parts by weight through mixing and reaction:
145-155 parts of polyisocyanate;
100 parts of polyol composition;
11.5-12.5 parts of C-pentane;
1.8-2.0 parts of catalyst;
2.0-2.3 parts of silicone oil;
1.9-2.1 parts of water; and
1-chloro-3,3,3-trifluoropropene accounting for 2.5%-3.0% of the total weight of the raw materials.

20. The method for manufacturing refrigerators or freezers according to claim 17, the aromatic polyether polyols obtained by the addition polymerization reaction of toluenediamine as an initiator and oxyalkylene account for 15-40 parts in weight in the polyol composition.
